(19) United States
(12) Patent Application Publication
(10) Pub. No.: US 2007/0172790 A1
(43) Pub. Date: Jul. 26, 2007

(54) Dental Vacuum System

(75) Inventors: Ronald W. Doucette JR., Troy, OH (US); David P. Hosey, Minster, OH (US); Tim Silvers, Versailles, OH (US); Michael R. Supinger, Russia, OH (US); Scott Strait, Greenville, OH (US)

Correspondence Address: WOOD, HERRON & EVANS, LLP, 2700 CAREW TOWER, 441 VINE STREET, CINCINNATI, OH, 45202, US

(73) Assignee: MIDMARK CORPORATION, Versailles, OH (US)

(21) Appl. No.: 11/275,747

(22) Filed: Jan. 26, 2006

(51) Int. Cl. A61C 17/06

(52) U.S. Cl. 433/92

(57) ABSTRACT

A dental vacuum system includes a vacuum reservoir and at least one positive displacement dry vacuum pump operatively coupled to the vacuum reservoir to create a vacuum in the reservoir. One or more dental aspirators are coupled to the vacuum reservoir through a conduit system, whereby vacuum pressure developed in the reservoir by the pump is applied to the aspirators. The vacuum pump operates without a working fluid in its pumping chamber.

### FIELD OF THE INVENTION

The present invention relates generally to dental apparatus, and more particularly to a dental vacuum system for use in dental operatories.

### BACKGROUND OF THE INVENTION

Dental vacuum systems have generally been employed to remove aerosols, liquids, solid debris and various other materials from the mouths of dental patients. Most dental offices include multiple operatories, each having one or more dental aspirators that are coupled via a conduit network to a dental vacuum system. Conventional dental vacuum systems typically utilize liquid ring pumps, regenerative blowers, or oil-lubricated rotary vane pumps to develop a vacuum pressure that is applied through the conduit network to the dental aspirators. The liquid ring pumps and oil-lubricated rotary vane pumps used in these systems generally require a high degree of maintenance, which in turn results in increased operating costs for such systems. In particular, liquid ring pumps and rotary vane pumps require a working fluid, generally water or oil, in the pumping chamber to seal and lubricate moving components of the pumps. These systems therefore require continuous monitoring of the liquid level to ensure that a sufficient amount of liquid is available during operation of the vacuum system. The efficiency of conventional vacuum systems suffer as a consequence of the energy that must be expended to move the working fluid around in the pumping chamber, and because of the additional power requirements and maintenance expended to monitor and control the liquid level in the pumping chamber.

While regenerative blowers do not require a working fluid in a pumping chamber, they exhibit significant flow losses over the conduit distances required for most dental vacuum systems. These flow losses decrease the efficiencies of regenerative blower systems.

A need therefore exists for improved dental vacuum system which overcomes these and other drawbacks of the prior art.

### SUMMARY OF THE INVENTION

The present invention provides a dental vacuum system that utilizes a positive displacement dry vacuum pump to develop vacuum pressure in a vacuum reservoir. The positive displacement dry vacuum pump operates without a working fluid in its pumping chamber, and therefore exhibits increased efficiency compared to conventional dental vacuum systems. Because the dry vacuum pump does not require a working fluid to develop vacuum pressure, there is no need to constantly monitor and maintain the level of a working fluid in the pumping chamber. Multiple dry vacuum pumps may be added to the vacuum system to provide increased flow capacity at a given vacuum pressure, if desired.

The dental vacuum system further includes one or more dental aspirators coupled to the vacuum reservoir by a conduit system. Vacuum pressure developed in the vacuum reservoir by the dry vacuum pump is thereafter applied to the individual dental aspirators through the conduit system. Aerosols, liquids, solid debris, and other material removed from patients' mouths by the aspirators are collected in the vacuum reservoir for subsequent disposal.

In one aspect of the invention, the dry vacuum pump is a rotary claw pump. In another aspect of the invention, two or more dry vacuum pumps may be coupled to the vacuum system to provide increased flow capacity at a given vacuum pressure. The dry vacuum pump may be driven by a motor operatively coupled to the pump. In one embodiment, the motor is mounted to the dry vacuum pump by a motor mount that is adjustable to vary the spacing between the motor and the dry vacuum pump.

In yet another aspect of the invention, the vacuum reservoir comprises a tank with an open end and a reservoir lid covering the open end. A gasket sealingly secures the reservoir lid to the tank without requiring additional fastening mechanisms.

These and other features, advantages, and objectives of the invention will become more readily apparent to those of ordinary skill in the art upon review of the following detailed description of the exemplary embodiments, taken in conjunction with the accompanying drawings.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the principles of the invention.

FIG. 1 is a perspective view depicting and exemplary dental vacuum system in accordance with the principles of the present invention;

FIG. 2 is a perspective view of an exemplary vacuum assembly of the dental vacuum system of FIG. 1;

FIG. 2A is a perspective view depicting an alternative embodiment of the vacuum assembly of FIG. 2;

FIG. 2B is a perspective view of another exemplary vacuum assembly for use with the dental vacuum system of FIG. 1;

FIG. 3 is a partial cross-sectional view of the vacuum reservoir of FIG. 2;

FIG. 4 is a cross-sectional detail of a gasket of the vacuum reservoir of FIG. 3; and

FIGS. 5 is an exploded perspective view of a pump assembly used in the vacuum assembly of FIG. 2.

### DETAILED DESCRIPTION

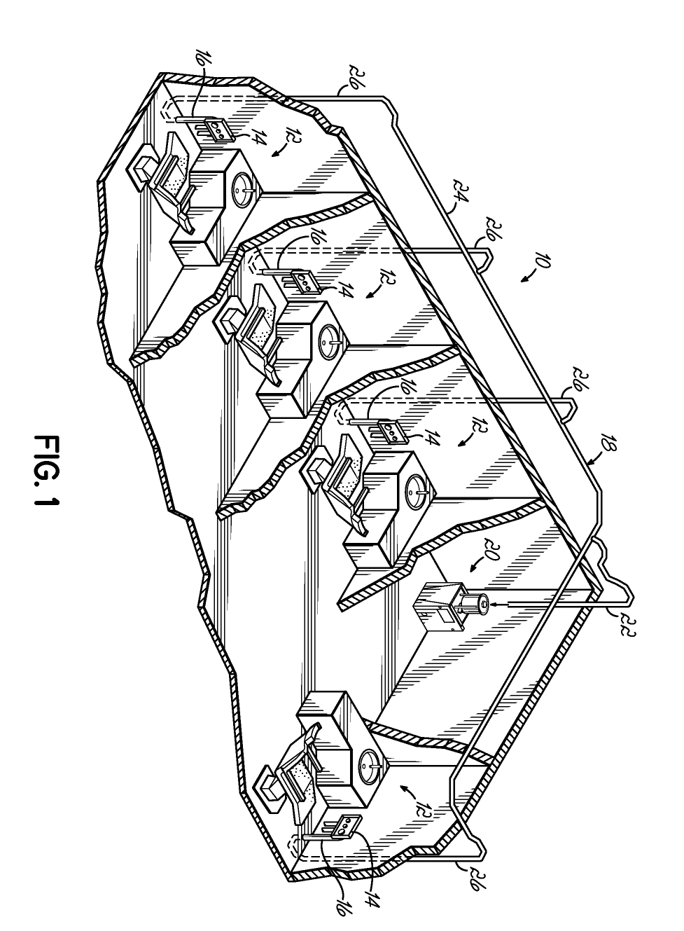

FIG. 1 illustrates a typical dental office including an exemplary dental vacuum system 10 in accordance with the principles of the present invention. The dental office includes one or more dental operatories 12, each having a station 14 that includes at least one dental aspirator 16. Each aspirator is connected via conduit system 18 to a common vacuum assembly 20 which provides vacuum suction through the conduit system 18 to the aspirators 16. The vacuum assembly 20 will generally be located remote from the operatories 12, such as in a separate room or a utility area of the dental office. The conduit system 18 includes a vacuum line 22 coupled at one end to the vacuum assembly 20. The vacuum line 22 communicates with a distribution line 24 which leads to a plurality of branch lines 26, each coupled to one of the aspirators 16.

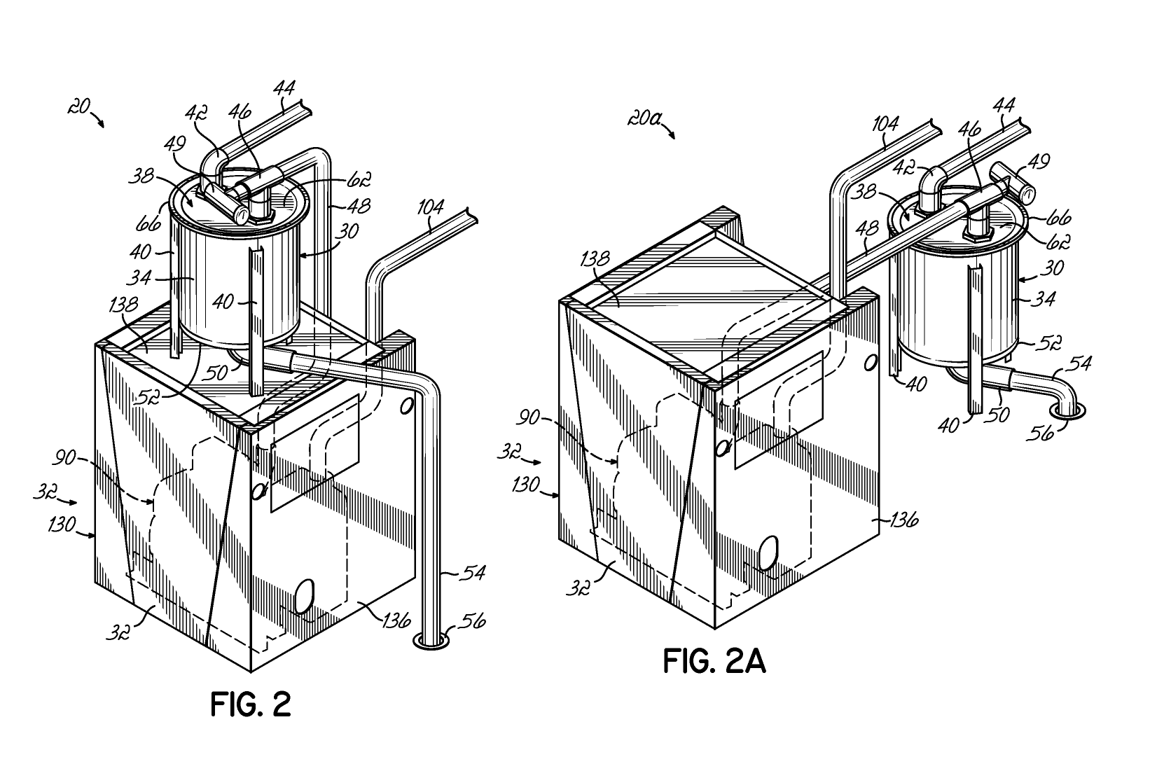

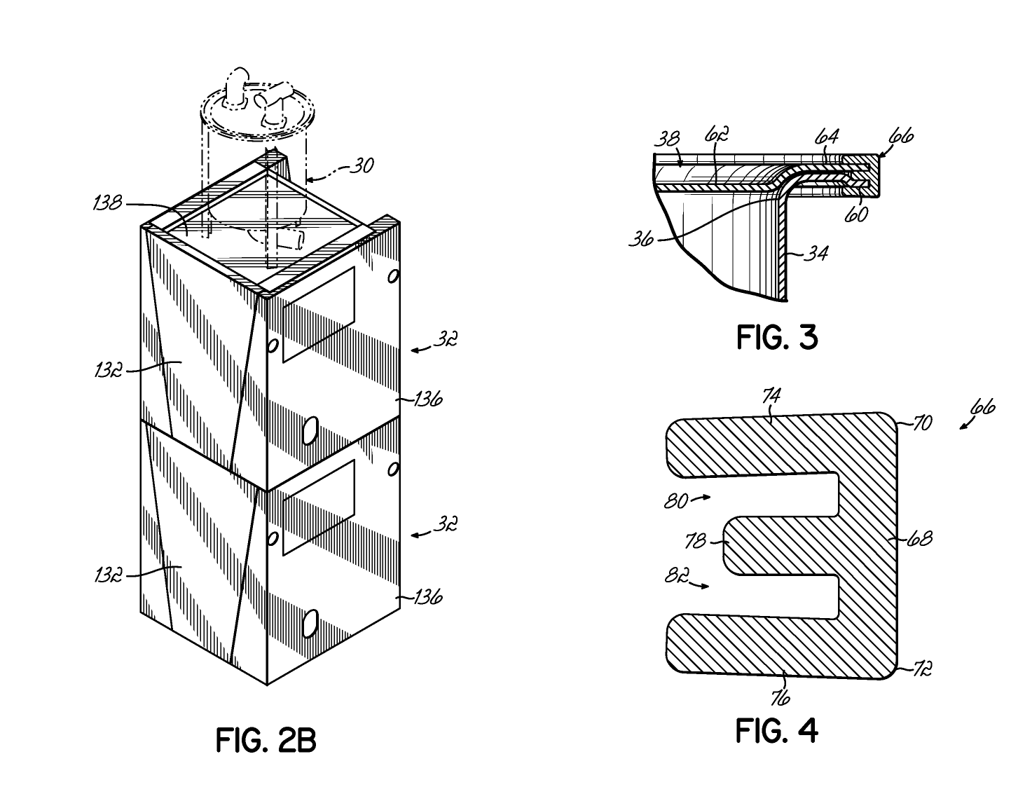

FIG. 2 illustrates the exemplary dental vacuum assembly 20 in more detail. Dental vacuum assembly 20 includes a vacuum reservoir 30 and a pump assembly 32. In the embodiment shown, reservoir 30 is mounted atop the pump assembly 32, but it will be recognized that the reservoir may alternatively be located adjacent the pump assembly 32, as depicted in FIG. 2A, or at various other locations as may be desired. Vacuum reservoir 30 includes a generally cylindrically-shaped tank 34 having an open end 36 (see FIG. 3) that is sealed by a reservoir lid 38. The reservoir 30 is supported by downwardly extending legs 40 provided on an outer periphery of the tank 34. In the embodiment shown, a first fitting 42 is coupled, for example, by flexible tubing 44, to the conduit system 18 to provide fluid communication between the vacuum reservoir 30 and the conduit system 18. A second fitting 46 is coupled, for example, by a flexible tubing 48, to the pump assembly 32 to provide fluid communication between the vacuum reservoir 30 and the pump assembly 32, as will be described in more detail below. The second fitting 46 may include a vacuum relief valve 49 that is adjustable to set a desired vacuum pressure in the vacuum reservoir 30. In the embodiment shown, the fittings 42, 46 are provided on the reservoir lid 38, but it will be recognized that the fittings 42, 46 may alternatively be provided on the tank 34. A drain fitting 50 provided on a lower end 52 of the tank 34 is coupled by a flexible tubing 54 to a floor drain 56. The drain fitting 50 may include a check valve (not shown) which is operative to prevent the flow of fluids and other material to the floor drain 56 when the vacuum assembly 20 is operating to provide vacuum suction to the aspirators 16. When the vacuum system 10 has been shut off, the check valve opens to permit liquids and other materials accumulated in the vacuum reservoir 30 to exit the drain fitting 50 to the floor drain 56.

While FIG. 2 depicts a vacuum assembly 20 including one pump assembly 32, multiple pump assemblies 32 may be coupled to the vacuum reservoir 30 to increase the vacuum capacity of the dental vacuum system 10, as may be desired. FIG. 2B, for example, illustrates another embodiment of a vacuum assembly 20a in accordance with the principles of the present invention wherein first and second pump assemblies 32 are coupled to the vacuum reservoir 30. The pump assemblies are connected in parallel to the vacuum reservoir 30 to thereby increase the vacuum capacity of the dental vacuum system. Such a configuration may require additional fittings to couple the vacuum assembly to the pump assemblies 32 and/or the conduit system 18. A given vacuum system 10 may also include multiple pump assemblies 20 and associated vacuum reservoirs 30 to provide increased flow capacity, as may be desired.

FIG. 3 illustrates the attachment of the reservoir lid 38 to the tank 34. In the embodiment shown, the open end 36 of the tank 34 includes an annular flange 60. The reservoir lid 38 has a generally depressed central portion 62 and a corresponding annular flange 64 sized and shaped to engage the annular flange 60 of the tank 34. The reservoir lid 38 is sealingly secured to the tank 34 by a sealing gasket 66 that fits over the respective outer peripheries of the tank 34 and lid flanges 60, 64. In one embodiment, the gasket 66 is formed from polymeric material, such as Neoprene®, however, various other materials suitable for retaining the reservoir lid 38 on the tank 34 while sealing the tank 34 may alternatively be used.

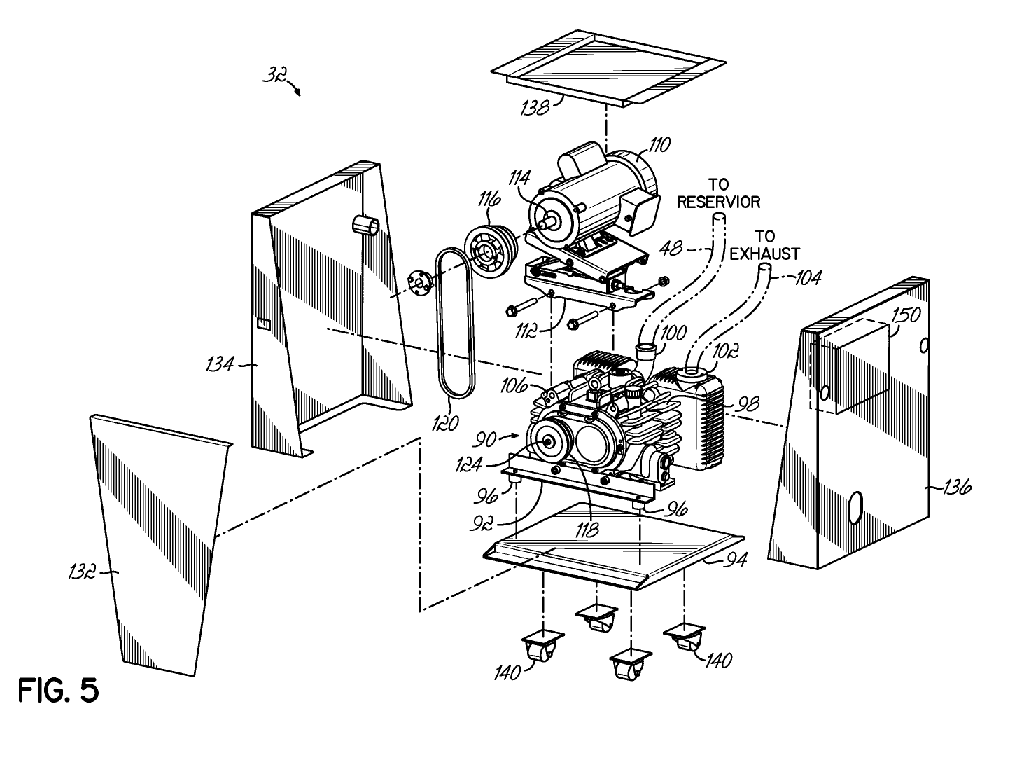

In the embodiment shown in FIG. 4, the gasket 66 comprises a back wall 68 having oppositely disposed first and second ends 70, 72. First and second opposed sidewalls 74, 76 proximate the first and second ends 70, 72 of the back wall 68 extend generally perpendicularly from the back wall 68 to define an annular channel section between the sidewalls 74, 76. The gasket 66 further includes an intermediate wall 78 disposed between the sidewalls 74, 76 and separating the channel into first and second portions 80, 82. The gasket 66 is sized such that the annular flange 64 of the lid 38 is received within the first channel portion 80 and the annular flange 64 of the tank 34 is received in the second channel portion 82 of the gasket 66. The sidewalls 74, 76 may be angled or tapered in a direction toward intermediate wall 78 to create a narrowing of the first and second channel portions 80, 82 so that gasket 66 fits snuggly against the flanges 60, 64 and seals the lid 38 to the tank 34. The gasket 66 may first be placed over the annular flange 64 of the reservoir lid 38 and then the lid 38 and gasket 66 may be fitted over the annular flange 60 of the tank 34 to thereby sealingly secure the lid 38 to the tank 34. Accordingly, no clamps, fasteners or other hardware is needed to sealingly secure the reservoir lid 38 to the tank 34.

Referring now to FIG. 5, the pump assembly 32 will be described in more detail. Pump assembly 32 includes a rotary claw pump 90, such as Part No. 029-3715-00 available from Midmark Corporation of Versailles, Ohio, mounted to a support frame 92 and supported on a base plate 94. Resilient, vibration isolators 96 may be provided between the support frame 92 and the base plate 94 to attenuate vibration of the pump 90. The pump 90 includes a pump chamber 98 which houses rotating claws (not shown) and operates without working fluid to develop vacuum pressure, as known in the art. An inlet port 100 is coupled to the vacuum reservoir 30 by the flexible hose 48, as depicted in FIG. 2, and an exhaust port 102 may be coupled to an exhaust line 104 routed to an appropriate location, such as a location outside the office. The pump 90 further includes a gearbox 106 for driving the rotary claws within the pump chamber 98. Motor 110 is mounted atop the pump 90 by a motor mount 112. An output shaft 114 on the motor is coupled by sheaves 116, 118 and a belt 120 to an input drive shaft 124 on the gearbox 106. The motor mount 112 is adjustable to position the motor 110 relative to the pump 90 whereby the tension of the drive belt 120 may be adjusted as required. Sheaves 116, 118 and belt 120 may be removed and replaced with sheaves of different diameters and a corresponding, appropriately-sized belt to vary the speed at which the motor 110 drives the rotary claws of the pump chamber 98, thereby varying the flow through the pump 90.

The pump 90 and motor 110 are enclosed in a housing 130 comprising a front wall 132 and first and second sidewalls 134,136 which may be secured to the base plate 94 by fasteners (not shown). A rear side of the pump assembly 32, opposite the front wall 132 is generally open to facilitate routing hoses 48 between the reservoir 30 and the pump 90, and to facilitate dissipating heat generated by the pump 90. The housing 130 further includes a panel 138 which may be useful for mounting the vacuum reservoir 30 above the pump assembly 32, as generally depicted in FIG. 2. Pump assembly 32 may also include casters 140 provided beneath the base plate 94 to facilitate installation of the vacuum assembly 20 in a dental office or other facility. A controller 150 may be mounted within housing 130 to provide power to motor 110 and may include PLC's or various other devices to control operation of the vacuum system 10.

In use, the vacuum assembly 30 is placed at a desired location, such as within a utility room of a dental office, and the inlet port 100 of the pump 90 is coupled to the second fitting 46 on the vacuum reservoir 30, such as by flexible hose 48. The first fitting 42 on the vacuum reservoir 30 is coupled via a flexible hose 44 and conduit system 18 to one or more dental aspirators 16, and the drain fitting 50 is coupled to a floor drain 56 or other appropriate disposal structure, such as by flexible hose 54. The exhaust port 102 of the pump 90 is coupled by a flexible hose to a vent or other appropriate location. Pump 90, driven by motor 110 evacuates air from vacuum reservoir 30 to develop a vacuum within the vacuum reservoir 30. The vacuum pressure is applied to the individual aspirators 16 through the conduit system 18. Because pump 90 is a dry vacuum pump, no working fluid is required in the pumping chamber 98, and the vacuum system 10 therefore does not require constant monitoring or periodic replacement of a working fluid, as is common with conventional dental vacuum systems.

A dental vacuum system in accordance with the principles of the present invention, such as the exemplary vacuum systems shown and described herein, provides a long service-life requiring minimal maintenance and does not require replacement of internal parts due to wear. The system is air cooled and has no internal parts that must be replaced due to wear. These features, along with reduced power requirements compared to known vacuum systems, result in low operating costs.

While the present invention has been illustrated by the description of one or more exemplary embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method and illustrative examples shown and described. Accordingly, departures may be made from such details without departing from the scope or spirit of the general inventive concept.

What is claimed is:

1. A dental vacuum system, comprising:
a vacuum reservoir;
at least one positive displacement dry vacuum pump operatively coupled to said vacuum reservoir to create a vacuum in said reservoir, said pump having a pumping chamber configured to operate without a working fluid in the pump chamber; and
at least one dental aspirator operatively coupled to said vacuum reservoir.

2. The dental vacuum system of claim 1, wherein said pump is a rotary claw pump.

3. The dental vacuum system of claim 1, comprising first and second dry vacuum pumps operatively coupled to said vacuum reservoir.

4. The dental vacuum system of claim 1, further comprising a motor operatively coupled to said dry vacuum pump.

5. The dental vacuum system of claim 4, further comprising a motor mount coupling said motor to said dry vacuum pump, said motor mount being adjustable to vary the position of said motor relative to said dry vacuum pump

6. The dental vacuum system of claim 1, further comprising a conduit system having a first end operatively coupled to said vacuum reservoir, and having at least one second end operatively coupled to said dental aspirator.

7. The dental vacuum system of claim 1, wherein said vacuum reservoir comprises:
a tank;
a lid; and
a gasket operative to sealingly secure said lid to said housing without requiring additional fastening mechanisms.

8. The dental vacuum system of claim 7, wherein said gasket comprises:
a back wall having first and second ends;
first and second opposed sidewalls proximate said first an second ends of said back wall, respectively, and defining a channel section together with said back wall; and
an intermediate wall disposed between said sidewalls and separating said channel section into first an second portions.

9. The dental vacuum system of claim 4, further comprising a housing at least partially enclosing said dry vacuum pump and said motor.

10. The dental vacuum system of claim 9, further comprising at least one caster disposed proximate a lower end of said housing to facilitate positioning the dental vacuum system in a desired location.
